(19) United States
(12) Patent Application Publication
(10) Pub. No.: US 2013/0073755 A1
(43) Pub. Date: Mar. 21, 2013

(54) DEVICE PROTOCOL TRANSLATOR FOR CONNECTION OF EXTERNAL DEVICES TO A PROCESSING UNIT PACKAGE

(71) Applicants: Greg Sadowski, Cambridge, MA (US); John W. Brothers, Sunnyvale, CA (US); Konstantine Iourcha, San Jose, CA (US)

(72) Inventors: Greg Sadowski, Cambridge, MA (US); John W. Brothers, Sunnyvale, CA (US); Konstantine Iourcha, San Jose, CA (US)

(73) Assignee: ADVANCED MICRO DEVICES, INC., Sunnyvale, CA (US)

(21) Appl. No.: 13/237,095

(22) Filed: Sep. 20, 2011

(51) Int. Cl. G06F 13/42

(52) U.S. Cl. 710/105

(57) ABSTRACT

A processing unit package includes a processing unit disposed on an interposer and a device protocol translator disposed on the interposer. Through-silicon vias (TSVs) may be used to provide connections from the device protocol translator through the interposer to an external device. The device protocol translator uses a controller to control a plurality of buffers that store information received from respective information buses coupled to the processing unit, such that the processing unit information is translated according to a protocol of the external device.

### FIELD OF INVENTION

This application is related to a device protocol translator used with a processing unit.

### BACKGROUND

Large frame buffer memory is required for a processing unit or a graphics engine to perform its functions. The memory devices are typically mounted on a printed circuit board (PCB) or an interposer outside of a packaged processing unit die. FIG. 1A shows a configuration 100 for such a processing unit and its associated memory. An interposer 101 is shown with a processing unit die 102 and four stacks of dynamic random access memory (DRAM) dies 103. The configuration 100 may be encapsulated as a single processing unit package.

FIG. 1B shows an alternative configuration 150 in which frame buffer memory devices are incorporated as DRAM dies 153 disposed directly on the main processing unit die 152 in the form of vertically stacked dies. Through-silicon via (TSV) technology may be used for electrical connections between the processing unit die 152 and memory dies 153.

Whether the frame buffer memory is incorporated directly on the processing unit die 152 as shown in FIG. 1B, or as a single encapsulated package mounted on a common interposer 101 as shown in FIG. 1A, one limitation is that there is no way of increasing the memory depth once the package design is set. One solution is to produce a variety of packaged processing unit/memory configurations with different depths of memory devices, but such configurations lack the flexibility of expandable memory.

Another limitation of the processing unit package configuration 100 of FIG. 1A and the processing unit 152 of FIG. 1B is where implementations require various input/output sizes to accommodate various multiple display arrangements, such as for driving two or more graphical displays. With a fixed processing unit package, there lacks a provision for adjustable input/output sizes to handle changes to the graphical display arrangement. Installing circuits on the processing unit die 102 or 152 to drive external devices, whether needed or not, adds complexity and cost to the processing unit die 102, 152.

### SUMMARY OF EMBODIMENTS

An apparatus and method of manufacture of the apparatus that includes a device protocol translator for connecting external devices, such as memory devices or other peripheral devices to an encapsulated processing unit (e.g., a graphical processing unit (GPU)) package. The device protocol translator is disposed on an interposer common with the processing unit to process read/write commands, and address information from the processing unit directed to external memory or external devices. A data bus and a return data bus carries data transferred between the processing unit and the external device via the device protocol translator.

### BRIEF DESCRIPTION OF THE DRAWINGS

FIGS. 1A and 1B show example physical configurations of a processing unit and memory package;

FIGS. 2A and 2B show example physical configurations of a processing unit with a device protocol translator for connection to external devices or external memory;

FIG. 3 shows an example physical configuration of the device protocol translator of FIG. 2 in an alternative configuration stacked with other memory dies;

FIG. 4 is an example functional block diagram of a device protocol translator configured for external memory;

FIG. 5 is an example functional block diagram of a device protocol translator configured for an external display;

FIG. 6 is an example functional block diagram of an embodiment having multiple translators;

FIG. 7 is an example functional block diagram of a device protocol translator having a field-programmable gate array configured for interface with an external device; and

FIG. 8 shows an example configuration of a device protocol translator for interfacing between a processing unit and an internal memory stack with a protocol not directly supported by the processing unit.

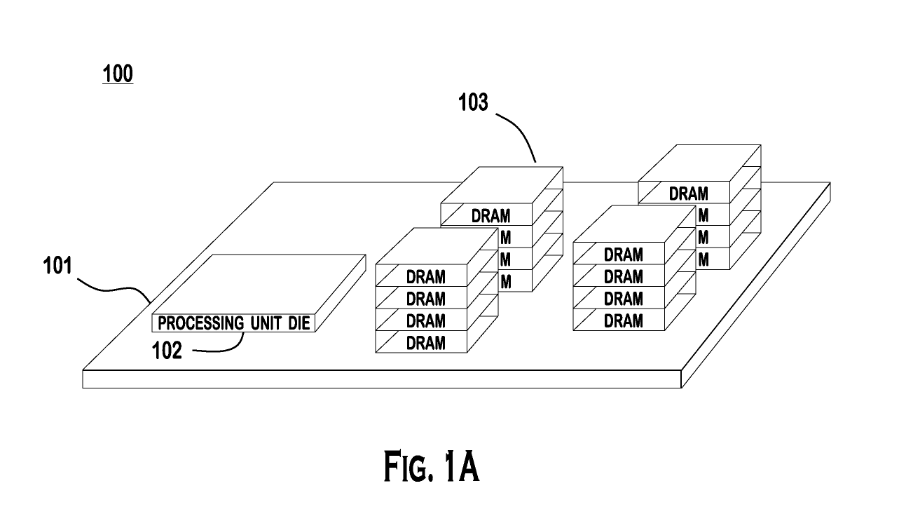

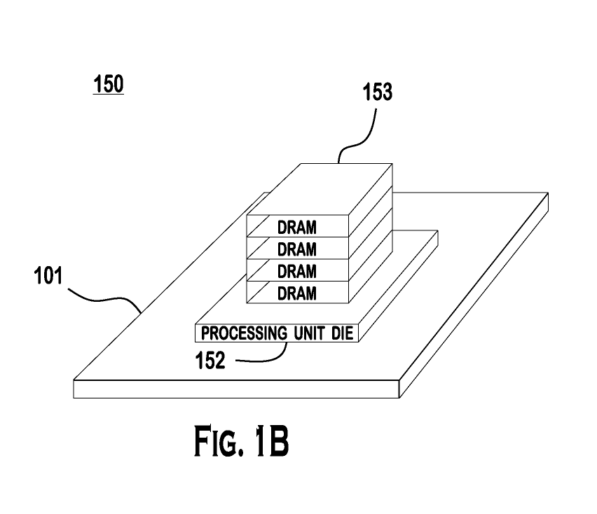

### DETAILED DESCRIPTION OF THE EMBODIMENTS

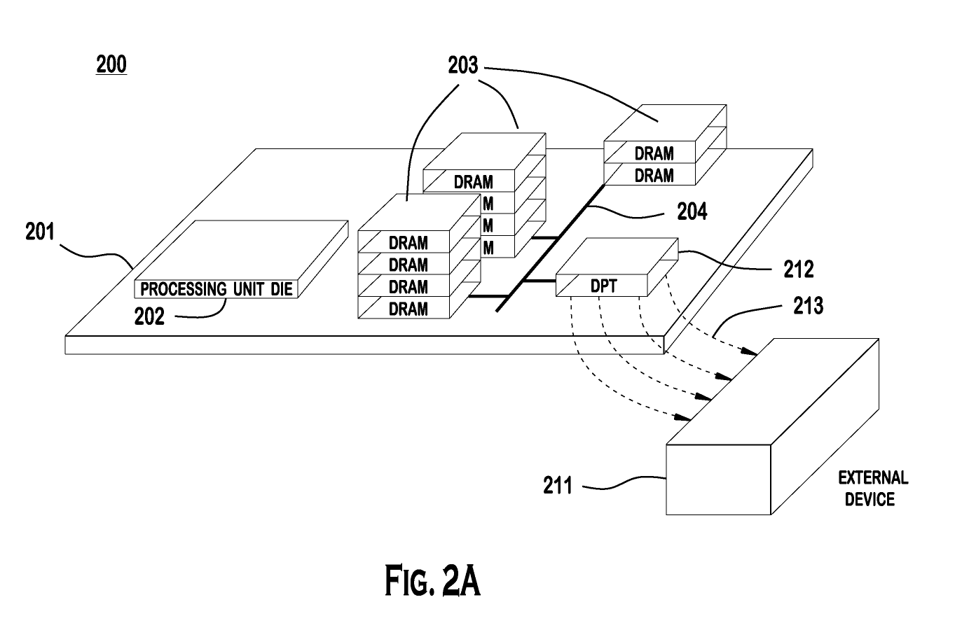

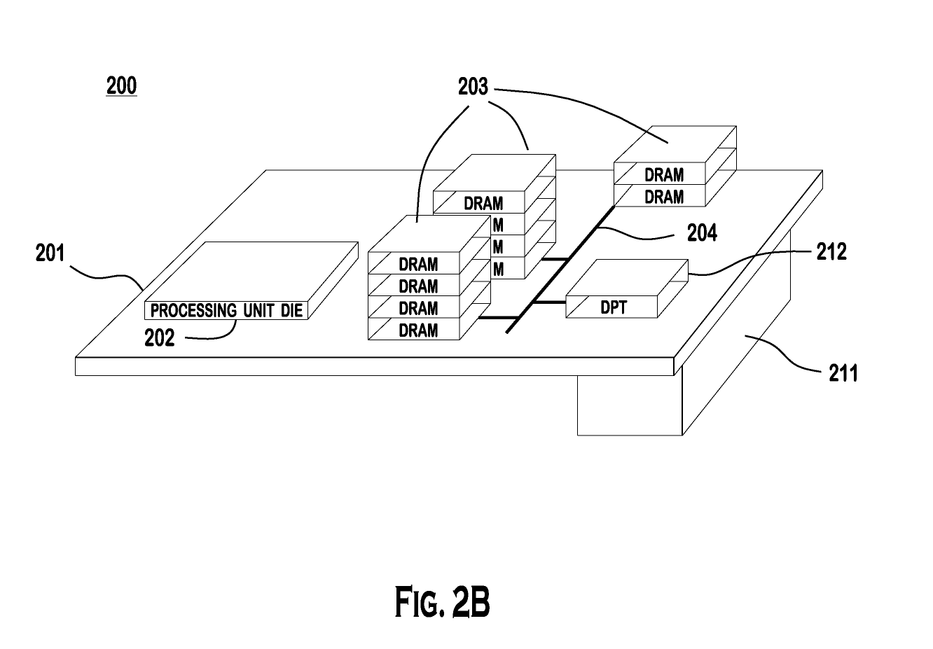

FIG. 2A shows a processing unit package 200, including an interposer 201 (e.g., a silicon interposer), a processing unit die 202 and internal memory dies 203, implemented as DRAM, disposed on the interposer 201 along with a device protocol translator (DPT) 212 that is configured to provide an interface 213 with an external device 211, such as external memory (DRAM) or an external display device. The processing unit die 202 and the DPT 212 are jointly disposed on a common interposer 201. The DPT 212 is designed to work with the internal memory dies 203 with capability to interface with the external device 211. The DPT 212 may be connected to an internal memory bus 204, shown here as a parallel connection to the internal memory dies 203. The processing unit package 200 may be encapsulated on the interposer 201. For external connections, before or after encapsulation of the processing unit package 200, the DPT leads 213 may pass through the interposer using through-silicon vias (TSVs). As shown in FIG. 2, the placement of the DPT 212 may be in place of (i.e., substituted for) one of the DRAM stacks 203. While a single DPT 212 and its corresponding interface 213 is illustrated in FIG. 2, this embodiment is not limited as such, and the processing unit package 200 may include multiple DPTs 212 and interfaces 213 as needed to allow for additional configurations with different types of external devices 211. Additionally, while the DPT 212 is illustrated as being connected to internal memory die stacks 203 via bus 204, other communication arrangements (e.g., point to point communication channels, communication fabrics, etc.) could also be employed and are subsumed with the term “bus”.

FIG. 2B shows the same processing unit package 200 of FIG. 2A, except that the external device 211 is mounted on a common interposer 201. In such a configuration, the external device may be connected to the DPT 212 using TSVs.

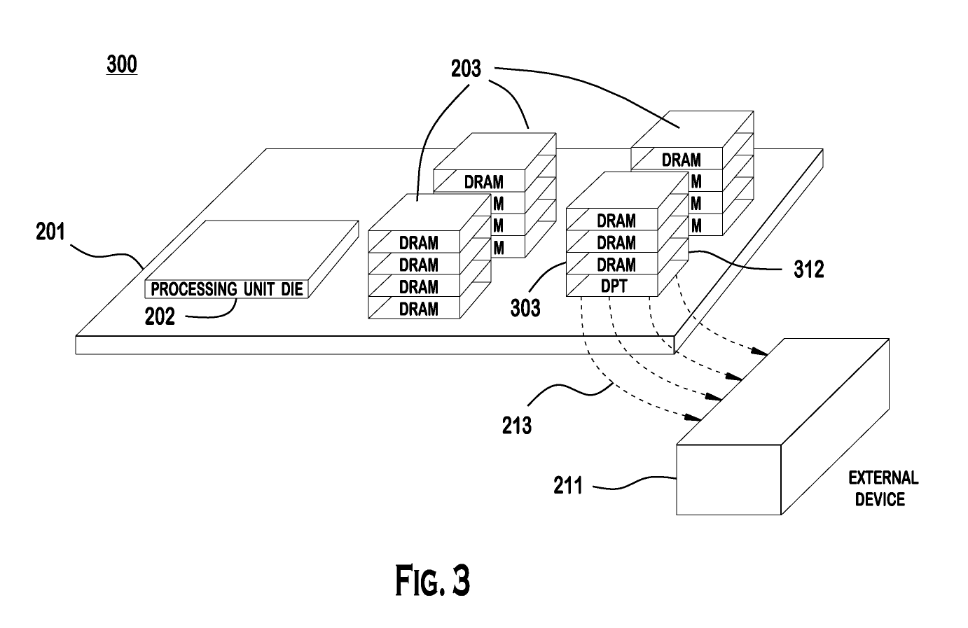

FIG. 3 shows an alternative processing unit package configuration 300, similar to the processing unit package 200, in which a DPT 312 is disposed at the bottom of a DRAM stack 303, using a vertical stacking technique. TSVs may be used to make electrical connections between the DRAM dies 303 and the DPT 312. Alternatively, the DPT 312 may be horizontally stacked with one or more DRAM dies 303. While a single DPT 312 and its corresponding interface 213 is illustrated in FIG. 3, this embodiment is not limited as such, and the processing unit package 300 may include multiple DPTs 312 and interfaces 213 as needed to allow for additional configurations with different types of external devices 211.

The processing unit packages 200 and 300 each provide a configuration that may employ internal memory only (e.g., DRAM 203, 303), or make use of external memory via DPT 212, 312, where the external device 211 is implemented as memory, or use both internal memory 203, 303 and external memory 211.

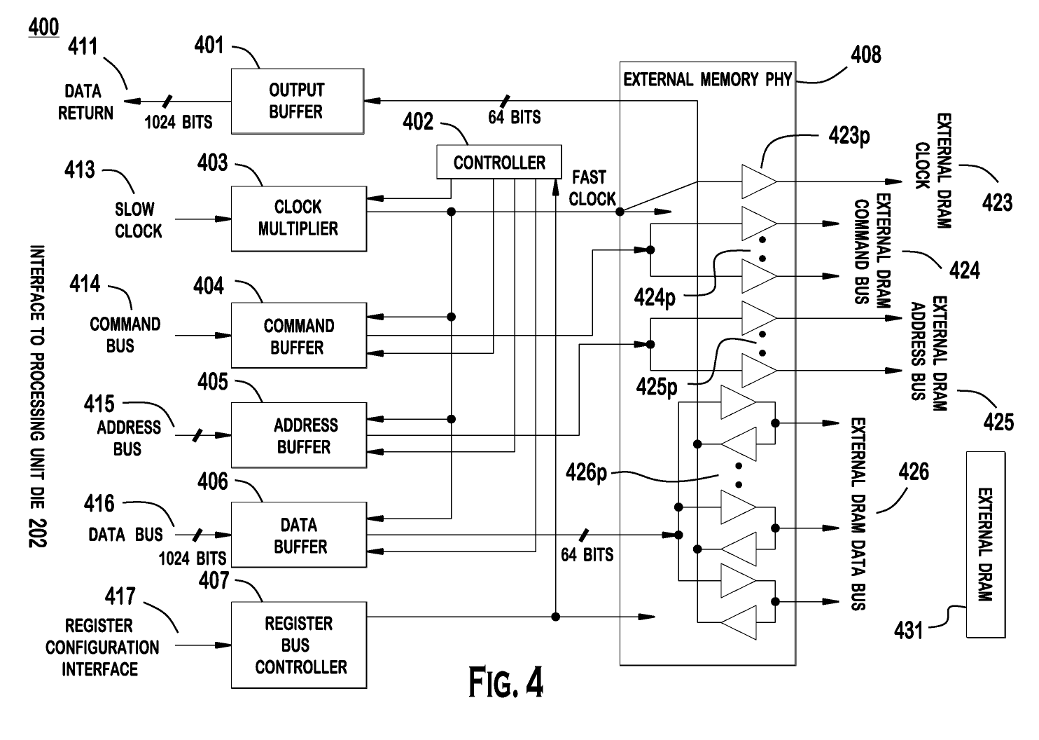

FIG. 4 shows a block diagram of an example translator 400 implemented in the DPT 212, 312, for interfacing with the external device 211 implemented as DRAM 431 of any size, providing expandable memory to the processing unit package 200, 300. The translator 400 in this example implementation includes an output buffer 401, a controller 402, a clock multiplier 403, a command buffer 404, an address buffer 405, a data buffer 406, a register bus controller 407 and an external memory physical interface 408.

The controller 402 is configured to perform control functions to the clock multiplier 403, command buffer 404, address buffer 405, and data buffer 406, using a protocol that complies with the external DRAM 431. The controller 402 may be a software programmable micro-controller or a reconfigurable hardware circuit (e.g., FPGA). The controller 402 receives instructions from the register configuration interface 417 from the processing unit 202 via the register bus controller 407. The controller 407 may also include training sequences for synchronizing fast interconnections executed by the external memory physical interface 408.

The clock multiplier 403 receives a slow clock signal 413 from the processing unit 202 and multiplies the clock signal to produce a fast clock signal in response to control information from the controller 402. The fast clock signal is sent via output port 423p as external DRAM clock signal 423. For example, the information from the processing unit 202 may run on a 500 MHz clock, which needs to be converted to a DRAM clock that runs at 8 GHz. The fast clock signal is used by the command buffer 404, the address buffer 405 and the data buffer 406 to process their inputs at a clock rate appropriate for the external DRAM buses. The fast clock signal is also used by any input/output gates or registers in the external memory physical interface 408 that are clocked.

The command buffer 404 receives commands from the processing unit 202 on the command bus 414, and converts the commands to DRAM protocol. The converted command is sent to an output port 424p on the physical interface 408, which is connected to the external DRAM command bus 424.

Address information from the address bus 415 is received by the address buffer 405 and converted according to the controller 402 input. The converted address information is sent to address ports 425p on the physical interface 408, and then on to the external DRAM address bus 425.

Write data from the processing unit 202 travels on the data bus 416 to the data buffer 406, where the data is converted in response to the controller 402 input. The data buffer 406 sends the converted data to a set of data ports 426p on the physical interface 408, and out to the external DRAM data bus 426. For example, the data bus 416 may be 1024 bit format converted to a 64 bit format used by the external DRAM 431.

Output buffer 401 receives read data and control data from the external DRAM data bus 426 at input ports 426p and converts the data from the external DRAM protocol back to the processing unit protocol for transmission on return data bus 411. For example, the output buffer 401 may convert a 64-bit data to a 1024-bit data signal. The data or control data may only requires two bit transmission, where the remaining return bus leads are driven to a bit value of zero.

The output ports 423p, 424p, 425p, and input/output ports 426p on the physical interface 408 may be implemented as clocked gates or registers connected by TSVs to electrical contact bumps at the bottom of the interposer, that may directly connect to mating contacts on a printed circuit board installation or contacts disposed on another interposer of an alternative package installation.

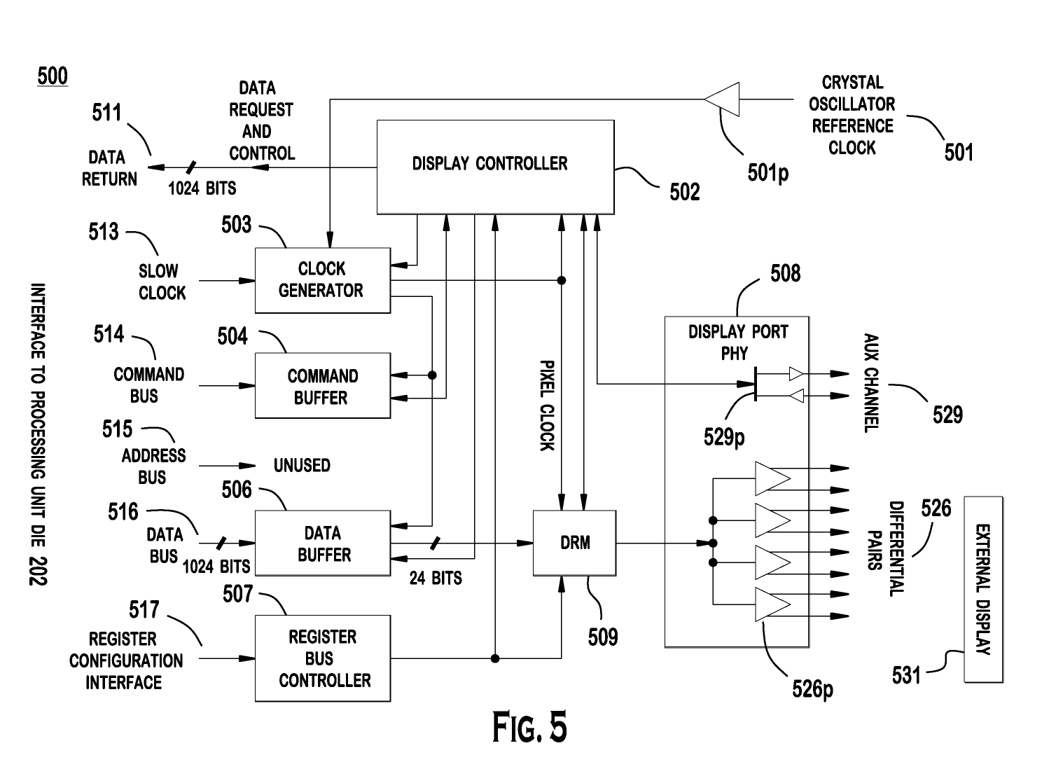

FIG. 5 shows a block diagram of an example translator 500 implemented in the DPT 212, 312 for interfacing with an external display device 211, where the external device 211 is implemented as an external display device 531. The DPT 212, 312 in this example implementation includes a display controller 502, a clock generator 503, a command buffer 504, a data buffer 506, a register bus controller 507 and a display port physical interface 508. As an example, the physical interface 508 may be implemented using the DisplayPort interface standard, as shown by the configuration in FIG. 5. However, this is by way of example only, and other alternative interface standards may be implemented without departing from the spirit and scope of the invention, such as HDMI. Accordingly, the physical interface 508 may include any functionality required for compliance with standard specifications for DisplayPort, HDMI, and/or the like. The display ports shown in FIG. 5 include differential pair ports 526p connecting to the differential pairs 526, and an auxiliary channel port 529p connecting to an auxiliary (AUX) channel 529. The auxiliary port 529p is connected to the display controller 502 for transfer of any auxiliary information.

The display controller 502 is configured to perform control functions to the clock generator 503, command buffer 504, and data buffer 506, using a protocol that complies with the display device.

An optional digital rights management (DRM) unit 509 may encrypt or watermark the display information to protect copyrighted works, and may limit access to the media, allowing only users having authorization, license or permission to view the media, and preventing sharing the media with unauthorized users. The display controller 502 is configured to perform control functions to the clock generator 503, command buffer 504, and data buffer 506, using protocol that complies with the external display. The display controller 502 may be a software programmable micro-controller or a reconfigurable hardware circuit (e.g., FPGA). The display controller 502 receives instructions from the register configuration interface 517 from the processing unit 202 via the register bus controller 507.

The clock generator 503 receives a slow clock signal 513 input from the processing unit 202 and produces a pixel clock signal based on received programmable control signals, including clock reference signal 501 from the crystal oscillator port 501p and a display resolution from the register bus controller 507. The reference clock signal 501 is used as a timing reference by a phase-locked loop (PLL) in the clock generator 503. The display resolution is included in the register configuration interface control signal 517 via the register bus controller 507 and the display controller 502. For example, clock generator 503 may convert a 500 MHz clock speed, which the information from the processing unit 202 may run on, to a pixel clock speed that complies with the required display resolution. The converted fast clock signal is used by the command buffer 504 and the data buffer 506 to process their inputs at a clock rate appropriate for the external display buses.

The command buffer 504 receives display control commands from the command bus 514, and converts the display commands to display protocol and sends it to the data buffer 506. The data buffer 506 receives display data from the data bus 516, converts the data in response to the controller 502 input, and command buffer 504 input, and sends the converted data to the optional DRM 509 for encryption. The encrypted data is sent to the differential pair ports 526p. If the optional DRM 509 is not employed, the converted data is directly sent from the data buffer 506 to the to the differential pair ports 526p of the physical interface 508. For example, the data bus 516 may be 1024 bit format, and the converted data may be 24 bit format.

The data request and control bus 511 provides return data and control information to the processing unit 202 from the external display device 531, via the display controller 502. For example, two bits of a 1024 bit bus may only be needed to handle the return data flow, and the remaining bus leads may be driven to zero. The data return bus 511 may be used to request data and control data from the processing unit 202 by sending a signal from the display controller 502 when forward data flow on data bus 516 is below a threshold, so as to minimize interruption of the forward data. The display controller 502 may receive the requested data on the data bus 516. The data return bus 511 may also be used by the processing unit 202 to read register information in the command buffer 504 and the data buffer 506 for diagnostic purposes.

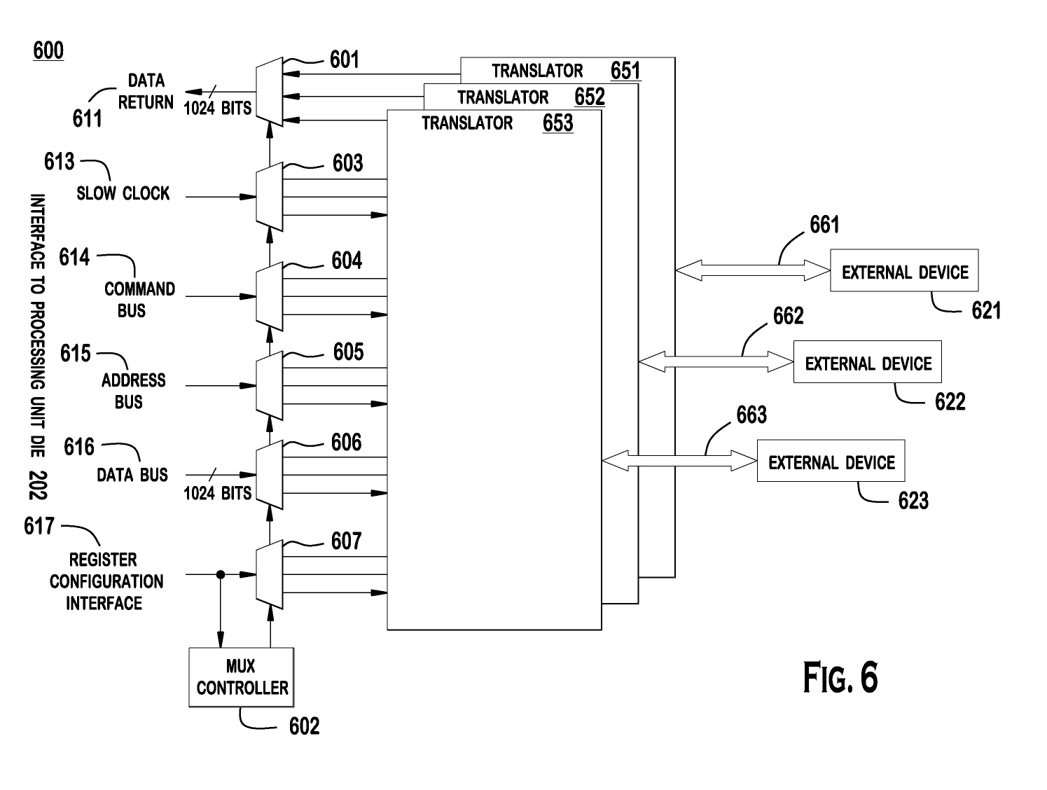

FIG. 6 shows a block diagram 600 of an example implementation for employing multiple translators 651, 652, 653 in a single DPT die 212, 312. The translators 651, 652, 653 may be configured as the translator 400, the translator 500 or a combination of both. Each translator 651, 652, 653 may interface with the processing unit 202 one at a time, by using multiplexers (MUX) 601, 603, 604, 605, 606, and 607 with MUX controller 602. Data return bus 611 is received from data return MUX 601. The slow clock input 613 from the processing unit 202 is distributed to the translators 651, 652, 653 via the MUX 603. Read and write commands from the processing unit 202 on command bus 614 are multiplexed by the MUX 604. Write data from data bus 616 is multiplexed by the MUX 606. Register write control messages sent from register configuration interface 617 are multiplexed by the MUX 607, and processed by the MUX controller 602, and include indication of which translator 651, 652, or 653 is selected for interfacing with the processing unit. The MUX controller 602 switches the MUXes 601, 603, 604, 605, 606, and 607 to activate the appropriate MUX output for the respective translator 651, 652, 653, allowing input and output access to the processing unit interface. The MUX controller 602 can use static switching, keeping a single translator active for a prolonged period, or dynamic switching according to time multiplexing between the various protocols, effectively allowing all included protocols to be functional in parallel.

Output ports 661, 662 and 663 interface between translators 651, 652 and 653 respectively, and external devices 621, 622, and 623, respectively. The output ports 661, 662, 663 may be configured as the physical interface 408 (FIG. 4) for an external DRAM, or as display port physical interface 508 (FIG. 5) for an external display device. Other equivalent configurations may be employed if compatible with other alternative external device types, including, but not limited to: GDDR5 DRAM, UBS port, HDMI interface, DVI interface, AES digital audio interface, or other standard or custom interface.

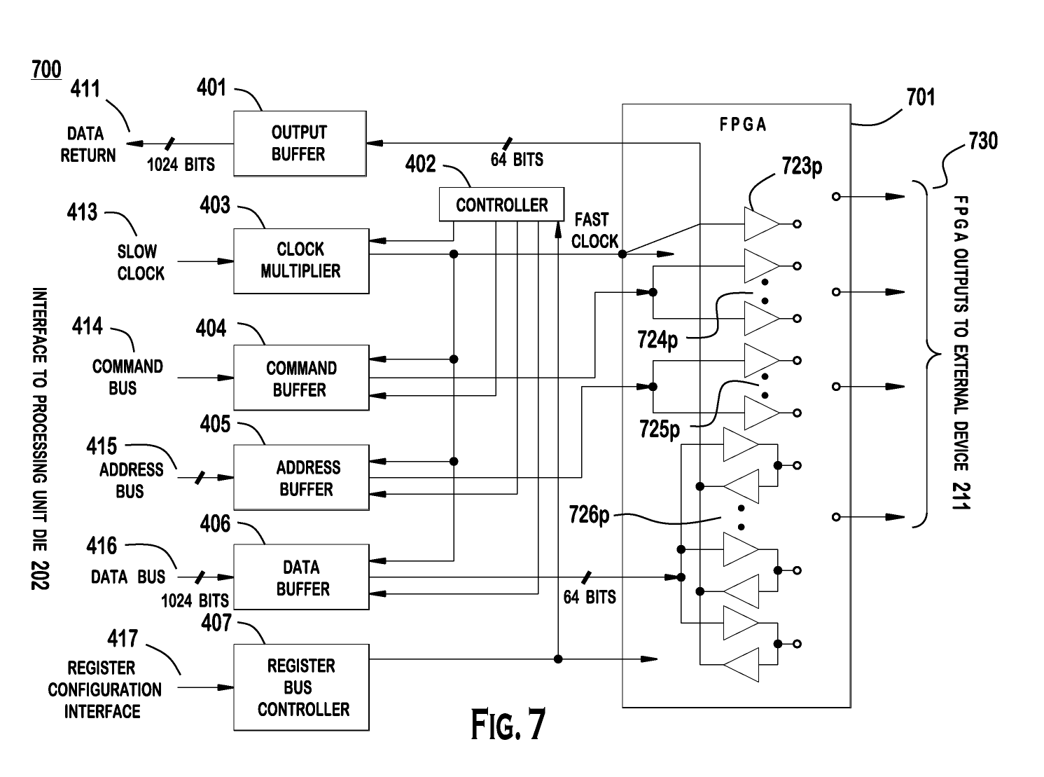

Although the DPT 212, 312 has been described above in reference to translating protocol for external DRAM 431 (i.e., translator 400) and for an external display device 531 (i.e., translator 500), other variations are included within the scope of this disclosure, for suitable translation of protocol for external devices 211 compatible for interface with the processing unit 202. For example, FIG. 7 shows an example configuration 700, which is similar to translator 400, except that a field-programmable gate array (FPGA) 701 provides a physical interface that can support a variety of external devices 211, such as a USB protocol device. This configuration 700 provides the flexibility for programming, and/or reprogramming as necessary, the logic of the DPT 212, 312 as required by the particular type of external device 211, such that in conjunction with the controller 407, protocol translation for the external device is achieved. Depending on the external device 211, the inputs of the FPGA 701 may or may not be utilized, similar to the translator 500, which does not make use of an address bus 415 or address buffer 405. Similarly, the FPGA outputs 730 may or may not be used, depending on the programming of the logic in the FPGA 701, which will configure the routing of protocol translated information from the output ports 723p, 724p, 725p, and 726p to the FPGA outputs 730 as needed.

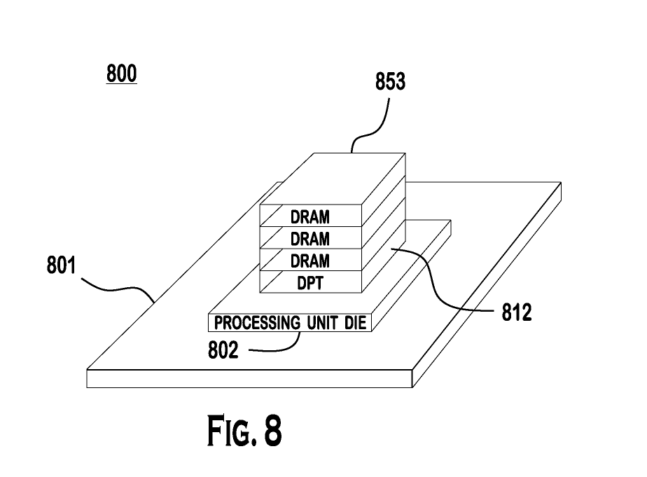

FIG. 8 shows an example processing unit and memory package 800, for protocol translation of internal memory, in which a DPT 812 is disposed between a processing unit die 802 and a vertical DRAM die stack 853. The processing unit 802 is disposed on an interposer 801. In this embodiment, the DPT 812 provides protocol translation between the processing unit 802 and DRAM dies 853 of a memory type that uses a protocol not supported by the processing unit 802. For example, as there are several available types of DRAM memory that could be selected for the DRAM dies 853 (e.g., GDDR5 and DDR2), the processing unit 802 may be designed for a single memory protocol for simplicity of design manufacturing and to minimize cost. Various modified versions of the DPT 812 may be fabricated according to the various available types of DRAM. A particular version of the DPT 812 may then be selected to match a respective DRAM 853 to be disposed on the processing unit and memory package 800. In this embodiment, the DPT 812 may be fabricated similar to translator 400, except that TSVs are implemented between the DPT 812 and an internal memory (i.e., DRAM 853), and between the DPT 812 and the processing unit die 802. Alternatively, the DPT 812 may implement a translator similar to the translator 700, in which a programmable logic is available for setting the protocol translation to a particularly selected memory type of the DRAM 853. While a single DPT 812 and a corresponding DRAM die stack 853 is illustrated in FIG. 8, this embodiment is not limited as such, and the unit package 800 may include multiple DPTs 812 with corresponding DRAM die stacks 853 as needed to allow for additional configurations with different types of DRAM memory. Furthermore, the processing unit and memory package 800 may be combinable with either of the processing unit packages 200 or 300, such that the interposer 801 has one or more DPTs 812 and one or more DPTs 212, 213 that interface with one or more external devices 211 in accordance with the embodiments described above.

As will be appreciated, embodiments of the present invention enable systems to be manufactured in a more flexible manner. For example, systems embodying certain aspects of the present invention may be enabled so as to obtain certain benefits of a package including a processing unit with memory stacks while also enabling the flexibility to communicate with other devices (e.g., external memories, processing units, different memory types, etc.), thus expanding certain desirable configurability of systems.

Although features and elements are described above in particular combinations, each feature or element can be used alone without the other features and elements or in various combinations with or without other features and elements. The apparatus described herein may be manufactured by using a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). The apparatus described herein may be fabricated using mask works or a processor design by execution of a set of codes or instructions stored on a computer-readable storage medium.

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data (e.g., netlists, GDS data, or the like) that may be used to perform a manufacturing process implemented in a semiconductor fabrication facility. The manufacturing process may be adapted to manufacture semiconductor devices (e.g., processors) that embody various aspects of the present invention.

Suitable processors include, by way of example, a general purpose processor, a special purpose processor, a conventional processor, a digital signal processor (DSP), a plurality of microprocessors, a graphics processing unit (GPU), a DSP core, a controller, a microcontroller, application specific integrated circuits (ASICs), field programmable gate arrays (FPGAs), any other type of integrated circuit (IC), and/or a state machine, or combinations thereof.

What is claimed is:

1. A method of manufacturing a system having a processing unit package, comprising:
disposing a processing unit on an interposer; and
disposing a device protocol translator on the interposer to allow connections from the device protocol translator through the interposer to at least one external device;
wherein the device protocol translator comprises a controller configured to control a plurality of buffers used for storing information received from respective information buses coupled to the processing unit such that the information is translated according to a protocol of the at least one external device.

2. The method as in claim 1, wherein the device protocol translator further comprises a field programmable gate array having logic that is programmed or reprogrammed such that in conjunction with the controller, protocol translation is achieved for the external device.

3. The method as in claim 1, further comprising disposing through-silicon vias (TSVs) in the interposer to provide electrical connections between the device protocol translator and the external device.

4. The method as in claim 1, further comprising disposing the external device on the interposer, wherein the external device is connected to the device protocol translator using the connections.

5. The method of claim 1, wherein the controller is further configured to translate a clock signal used by the processing unit to a clock signal in accordance with a protocol of the at least one external device.

6. The method of claim 1, wherein the device protocol translator further comprises:
a plurality of translators, each translator configured for connection to at least one external device;
a plurality of multiplexers, each multiplexer input coupled to one of the respective information buses from the processing unit, each multiplexer output coupled to a respective translator; and
a multiplexer controller with an input connected to a register configuration interface and a control output coupled to each of the multiplexers for controlling information from the processing unit to a single active translator or for dynamic switching of active translators according to time multiplexing between the external device protocols.

7. The method as in claim 1, further comprising:
disposing at least one dynamic random access memory (DRAM) die on the interposer, the DRAM connected to the processing unit.

8. The method as in claim 6, further comprising:
disposing the at least one DRAM die in a vertical stack with the device protocol translator, electrically coupled to the device protocol translator.

9. The method as in claim 6, further comprising:
disposing the at least one DRAM die in a horizontal stack with the device protocol translator, electrically coupled to the device protocol translator.

10. A device protocol translator disposed on a silicon interposer jointly with a processing unit, comprising:
a plurality of buffers coupled to a plurality of information buses carrying information from the processing unit;
a register bus controller coupled to a register configuration interface of the processing unit;
a controller adapted to control the plurality of buffers based on control signals received from the register bus controller, wherein the controller controls buffer outputs in accordance with a protocol of an external device; and
a physical interface configured to multiplex information received from the plurality of buffers and the register bus controller, to send the information translated at a voltage and a signaling rate adapted to the protocol of the external device.

11. The protocol translator of claim 10, wherein the plurality of buffers includes at least one of the following:
a command buffer coupled to a command bus to receive commands from the processing unit;
an address buffer coupled to an address bus to receive addresses from the processing unit; and
a data buffer coupled to a data bus to receive data from the processing unit.

12. The protocol translator of claim 10, wherein the external device is at least one dynamic random access memory (DRAM) unit.

13. The protocol translator of claim 10, wherein the external device is an external display device.

14. The protocol translator of claim 10, wherein the physical interface includes a through-silicon via to carry the translated information through the interposer from the protocol translator to the external device.

15. The protocol translator of claim 10, further comprising:
a clock generator controlled by the controller to translate a clock signal used by the processing unit to a clock signal in accordance with a protocol of the external device.

16. The protocol translator of claim 10, further comprising:
a plurality of translators, each translator configured for connection to a respective external device;
a plurality of multiplexers, each multiplexer input coupled to one of the respective information buses from the processing unit, each multiplexer output coupled to a respective translator; and
a multiplexer controller with an input connected to a register configuration interface and a control output coupled to each of the multiplexers for controlling information from the processing unit to a single active translator or for dynamic switching of active translators according to time multiplexing between the external device protocols.

17. A computer readable medium having instructions stored thereon that, when executed, control an interface between a processing unit and an external device to perform a protocol translation of processing unit information, performing the following steps:
receive read/write commands from a processing unit;
receive information stored in buffer memory;
receive a clock signal;
convert a voltage and signaling rate of the received commands, information and clock signal, to a converted voltage and signaling rate compatible with protocol of the external device.

18. The medium of claim 17, wherein the protocol is compatible with a USB device.

19. The medium of claim 17, wherein the protocol is compatible with a DRAM device.
